(19) United States
(12) Patent Application Publication
(10) Pub. No.: US 2007/0065645 A1
(43) Pub. Date: Mar. 22, 2007

(54) Structure for terminating underfilm corrosion

(76) Inventors: Oliver Steinbock, Tallahassee, FL (US); Stephanie D. Thouvenel-Romans, Cantonment, FL (US)

Correspondence Address: Pennington, Moore, Wilkinson,;Bell & Dunbar, P.A., Post Office Box 10095, Tallahassee, FL, 32302-2095, US

(21) Appl. No.: 11/228,745

(22) Filed: Sep. 16, 2005

(51) Int. Cl. B32B 3/30

(52) U.S. Cl. 428/167; 428/156; 428/172

(57) ABSTRACT

A new structure and method for terminating underfilm corrosion. The method utilizes patterned coatings on metal surfaces creating spatial variations of coating thickness or composition. The resulting structure, or paths of structural variation in the coating, directs the path of filiform growth and promotes entrapment, thereby limiting filiform growth and causing self-annihilation. In the preferred embodiment a stamp is used to impose the desired “paths” of structural variation in the painted coating while the coating is wet.

### BACKGROUND OF THE INVENTION

1. Field of the Invention

This invention relates to the field of corrosion control. More specifically, the invention comprises a structure and method for controlling underfilm and filiform corrosion by the application of patterned coatings on metal surfaces.

2. Description of the Related Art

Corrosion is a major concern to industries who utilize steel and aluminum alloys or any other reactive surfaces. Underfilm corrosion (sometimes referred to as filiform corrosion), like other forms of corrosion, is an electrochemical reaction that occurs when metals are exposed to moisture and oxygen in the atmosphere. This kind of corrosion typically occurs under coated surfaces that are exposed to high relative humidity. Underfilm or filiform corrosion leads to the deposition of a multitude of rust trails on metal surfaces, which can be both unsightly and damaging to the surface's physical properties such as reflectivity. Underfilm corrosion is particularly significant to companies that employ metal-based materials and products that need to endure long-term storage before use or distribution to customers, especially those who employ metal cans for storage of their product.

Rust filaments have a width up to 4 mm and can extend over several decimeters. Active corrosion occurs only at the filiform head. This region is an oxygen concentration cell for which potential differences of up to 360 mV have been reported. Filiforms progress across the surface in a serpentine or linear fashion and the path of corrosion they leave is commonly referred to as the tail of the filiform. Since filiforms do not cross inactive tails of other filaments, they can become trapped and eventually “die” as the available space decreases.

Current technology protects metal surfaces with coatings of a generally uniform thickness and composition. While this is sometimes helpful to prevent the onset of corrosion, these homogenous coatings are ineffective to prevent the spread of underfilm corrosion once it has nucleated. The primary goal of the present invention is to control and exterminate corrosion once it has begun.

### BRIEF SUMMARY OF THE INVENTION

The present invention comprises a new method and structure for terminating underfilm corrosion. The method utilizes patterned coatings on metal surfaces creating spatial variations of coating thickness or composition. The resulting structure, or paths of structural variation in the coating, directs the path of filiform growth and promotes entrapment, thereby limiting filiform growth and causing self-annihilation. In the preferred embodiment a stamp is used to impose the desired “paths” of structural variation in the painted coating while the coating is wet.

### BRIEF DESCRIPTION OF THE SEVERAL VIEWS OF THE DRAWINGS

FIG. 1 is a perspective view, showing a coated metal object.

FIG. 2 is a perspective view, showing filiform corrosion on a coated metal object.

FIG. 3 is a perspective view, showing filiform self-entrapment.

FIG. 4 is a perspective view, showing a coated metal object with varying coating thickness.

FIG. 5 is a cut-away view, showing a coated metal object with varying coating thickness.

FIG. 6 is a perspective view, showing a stamp with concave spiral design.

FIG. 7 is a perspective view, showing a patterned surface with spiral design.

FIG. 8 is a perspective view, showing pattern-aided filiform entrapment.

FIG. 9 is a perspective view, showing a surface treated with spiral pattern design.

FIG. 10 is a perspective view, showing spiral patterns at various phases relative to each other.

FIG. 11 is a perspective view, showing a patterned surface with a diamond design.

FIG. 12 is a perspective view, showing a double spiral design.

FIG. 13 is a perspective view, showing an “s” spiral design.

### REFERENCE NUMERALS IN THE DRAWINGS

10 metal
12 coating
14 coated metal object
16 rust filament
18 trough
20 peak
22 plateau
24 stamp
26 concave spiral
28 convex spiral
30 spiral pattern
32 entrapment region
34 convex diamond
36 diamond pattern
38 double spiral
40 “s” spiral

### DESCRIPTION OF THE INVENTION

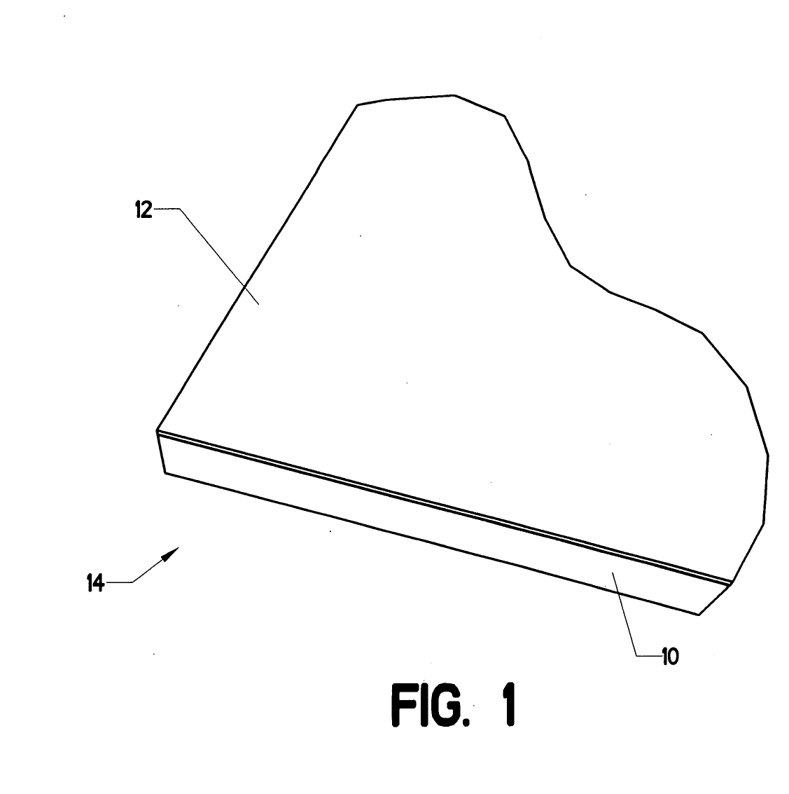

FIG. 1 shows a perspective view of a coated metal object, designated coated metal object 14. Coating 12 is deposited over metal 10. Metal 10 can be any metal such as iron and aluminum or any of their alloys, and coating 12 can be any type of coating applied to metal or metal alloys, including acrylic.

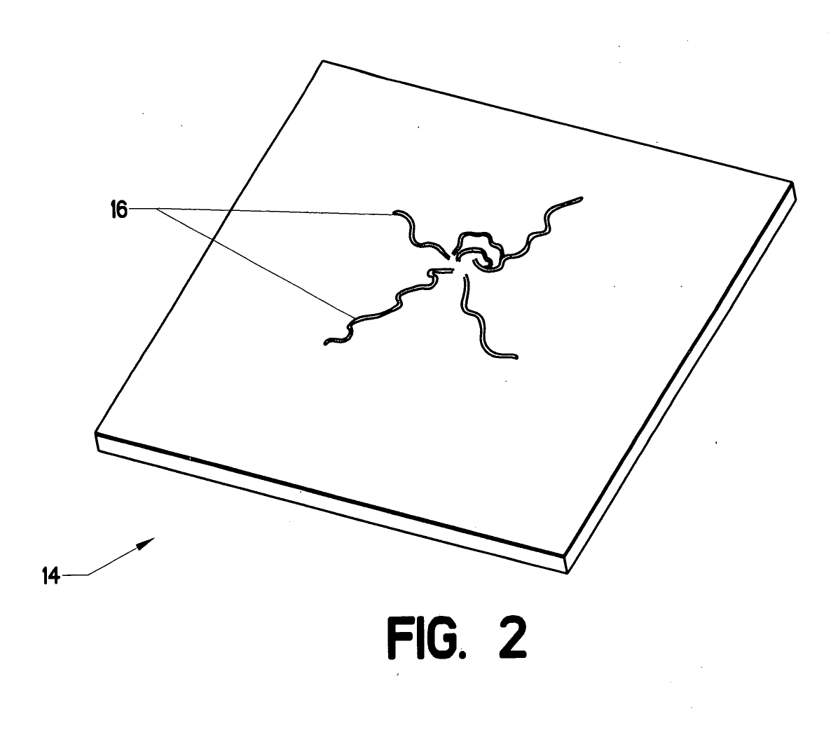

Coated metal objects are highly susceptible to underfilm corrosion. Underfilm corrosion begins when the metal substrate is exposed to moisture and oxygen. This can occur because of imperfections in the coating or because of the diffusion of oxygen and water through the coating. FIG. 2 illustrates typical filiform corrosion on a coated metal object. Rust filaments 16 follow paths that approximately radiate from a point of origin.

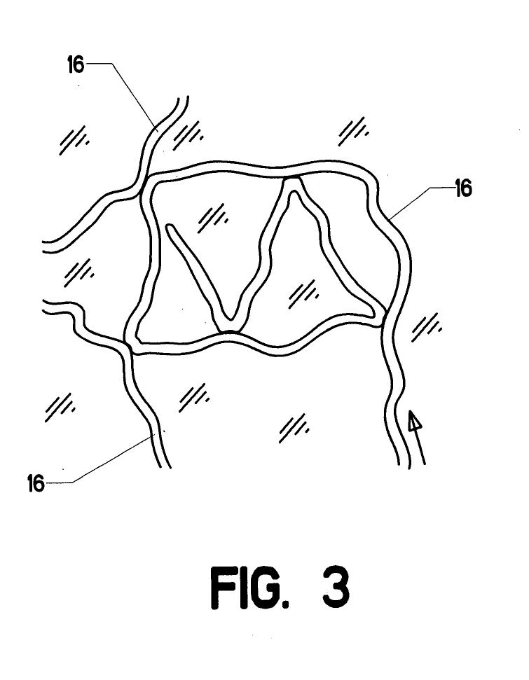

As filiforms grow or propagate, they occasionally have an opportunity to interact. Those skilled in the art know that an active filiform head will not cross an inactive tail of a rust filament. Instead filiform heads “reflect” from the tail and can become entrapped as the space available for the filiform to grow diminishes. FIG. 3 shows a detail view of the self-entrapment of rust filament 16. The arrow in FIG. 3 indicates the direction of propagation of filiform 16. As rust filament 16 propagates it reflects off both the tails of other filiform and its own tail. After several reflections, rust filament 16 creates an inactive perimeter which it cannot cross and its growth is thereby limited to the region within the inactive perimeter.

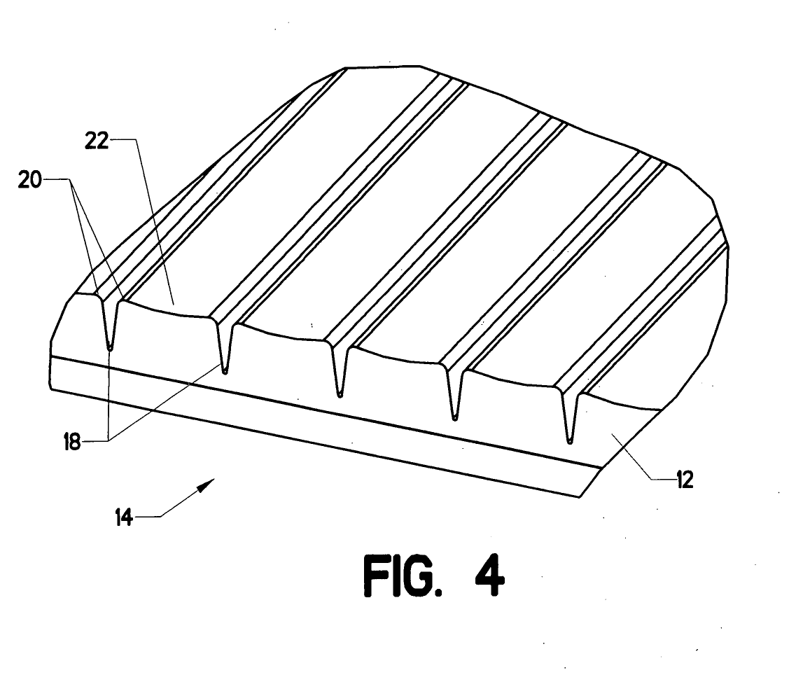

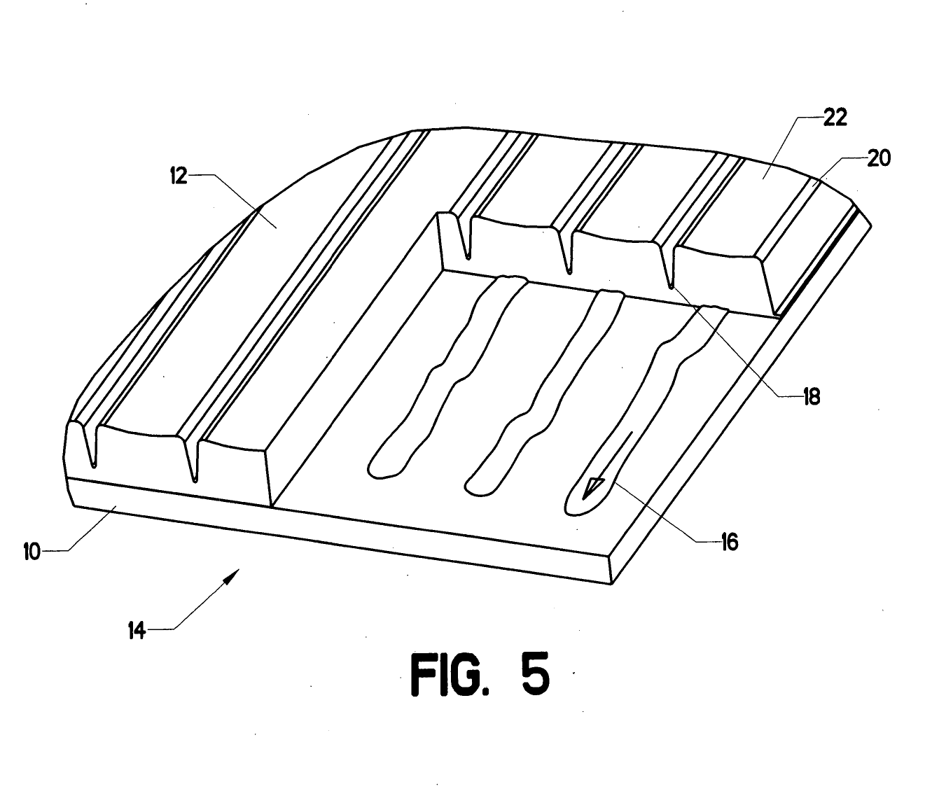

The general concept of this invention is to facilitate filiform self-entrapment by controlling the direction of filiform growth. It has been shown that filiform growth can be controlled by creating spatial variation of the coating thickness. FIG. 4 shows a coated metal object with varying coating thickness. Coating 12 is profiled in such a way to have a series of troughs 18, peaks 20, and plateaus 22. FIG. 5 shows a cut-away view of coated metal object 14 and illustrates how rust filaments 16 grow under plateaus 22. It is noted that rust filaments 16 tend to grow in a relatively straight path under plateaus 22 and do not cross trough 18 regions. Thus, the coating thickness controls the direction of filiform growth.

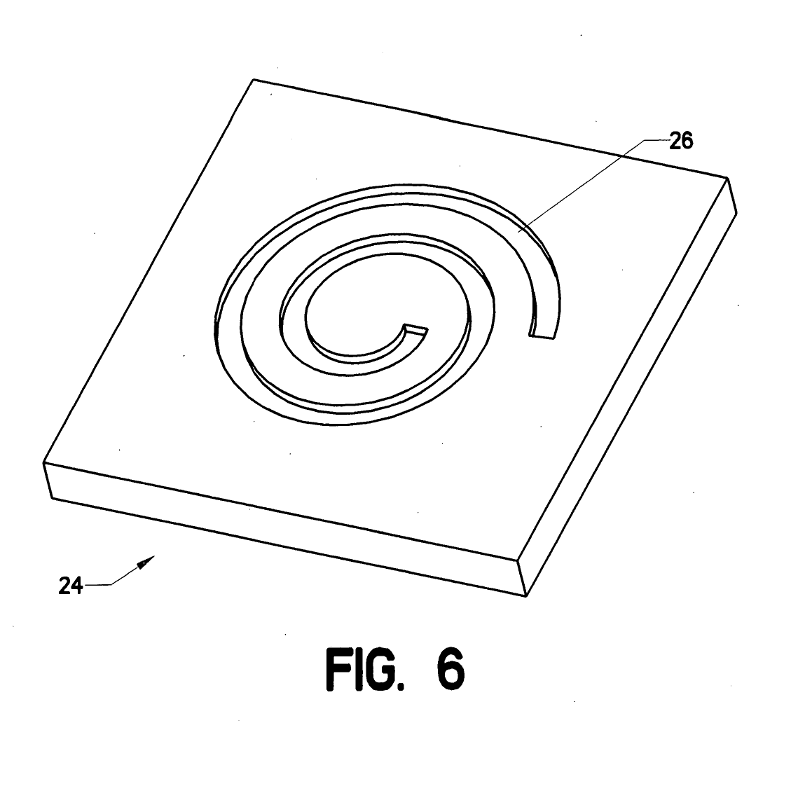

One way to create spatial variation of coating thickness involves the application of a micro-patterned polydimethylsiloxane (PDMS) stamps into a drying acrylic film. The PDMS stamps can be made by inexpensive soft-lithography, but other materials and techniques are applicable too. FIG. 6 shows a perspective view of stamp 24 impressed with the profile of concave spiral 26.

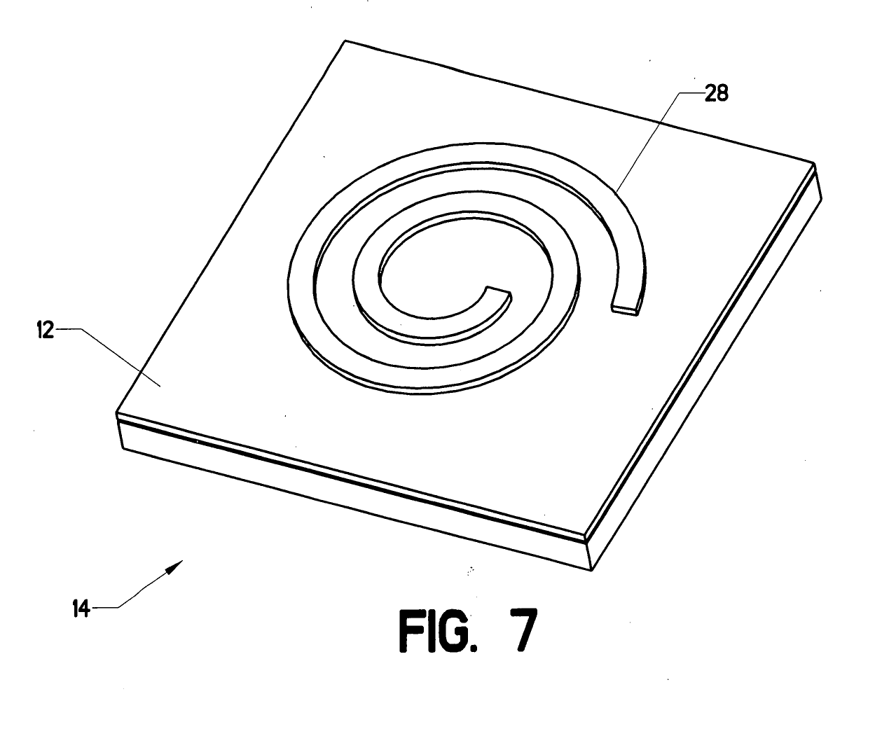

FIG. 7 shows a highly-magnified view of a patterned coating created by impressing stamp 24 of FIG. 6 onto a drying acrylic surface. Coating 12 is uniformly applied to the metal surface, and stamp 24 is pressed onto coating 12 while it is still wet. When the stamp is removed, convex spiral 28 is the resulting design on coating 12. This pattern remains on the coating after it dries.

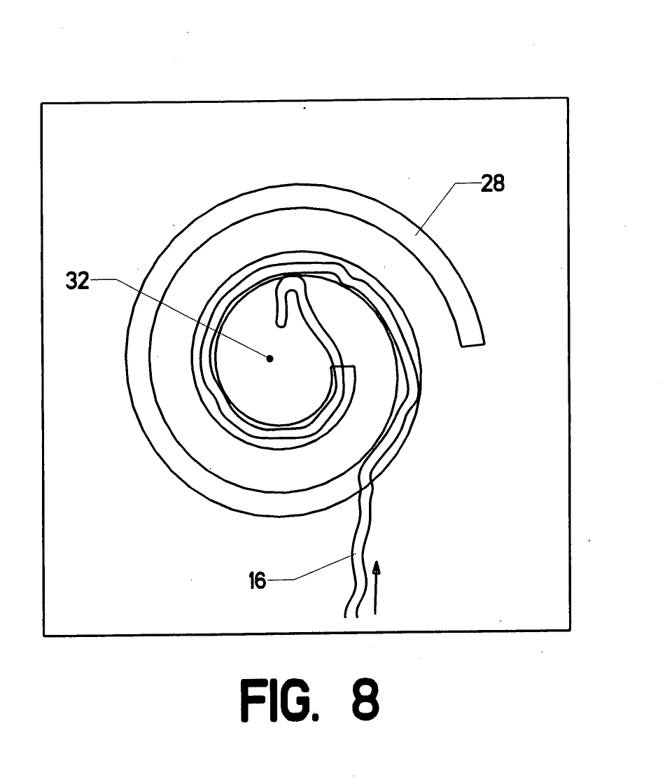

FIG. 8 illustrates how patterns can be used to entrap filiforms. Since rust filament 16 is only active at its head, it generally grows in one direction. When presented with a patterned surface, rust filament 16 follows the path much like a mole follows a tunnel, as demonstrated in FIG. 5, where rust filament 16 only grew under plateaus 22. When rust filament 16 reaches convex spiral 28 it follows the pattern into entrapment region 32. When the rust filament reaches this point, it has become entrapped and can no longer propagate.

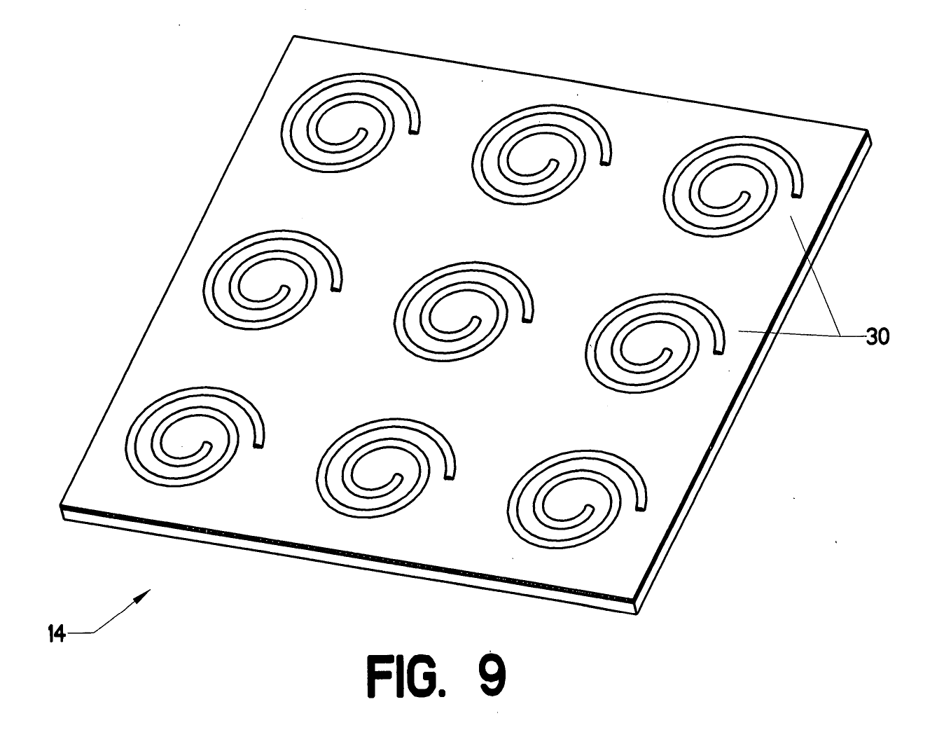

FIG. 9 shows how the entire surface of coated metal object 14 can be treated with spiral pattern 30. The application of spiral pattern 30 over the entire surface greatly limits the distance a filiform can grow before being entrapped.

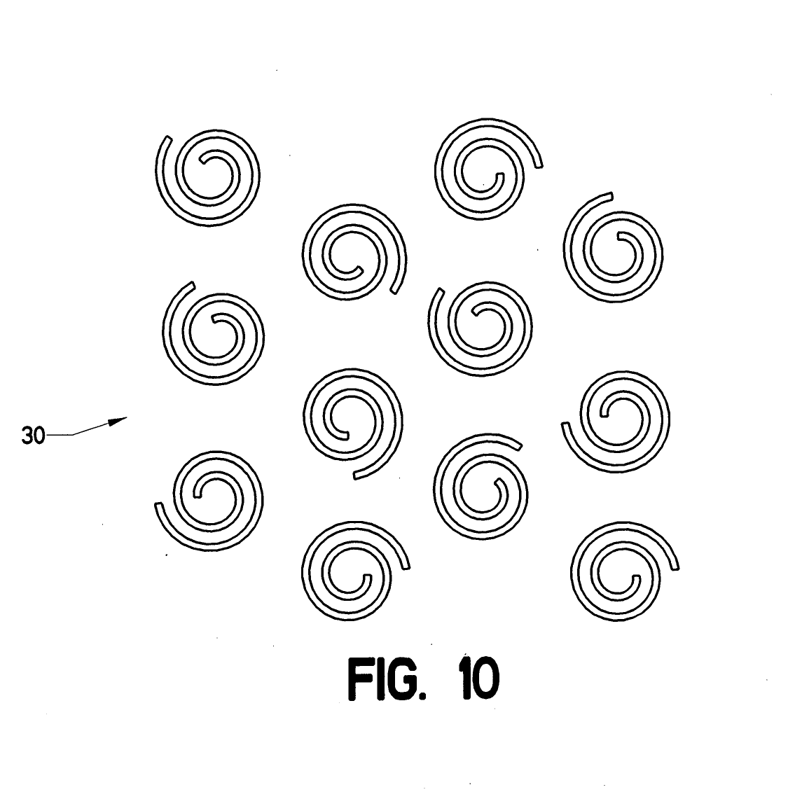

Since the precise origin of the filiforms and their bearings can seldom be anticipated various rotational offsets are used to “attract” filiforms into the patterns. FIG. 10 illustrates the rotational offset that can be used in spiral pattern 30. Each spiral is depicted at a phase angle that is relatively different than that of the adjacent spirals. The variation in phase angle or angular offset of the patterns increases the probability that a filiform will find a path to grow into entrapment region 32 regardless of which direction the filiform is growing.

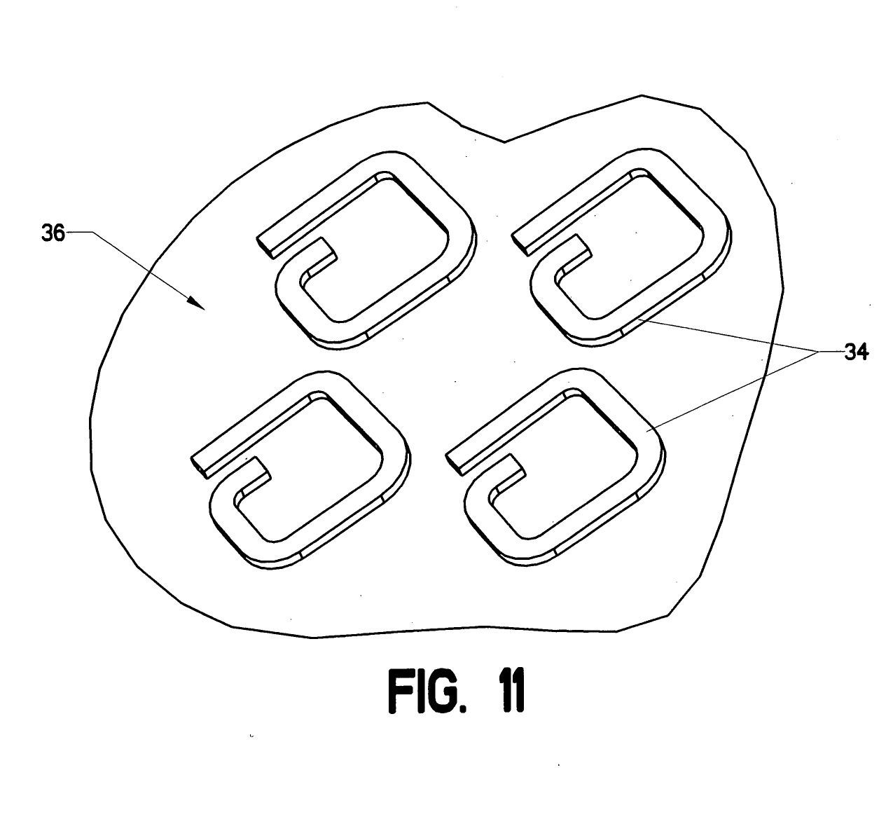

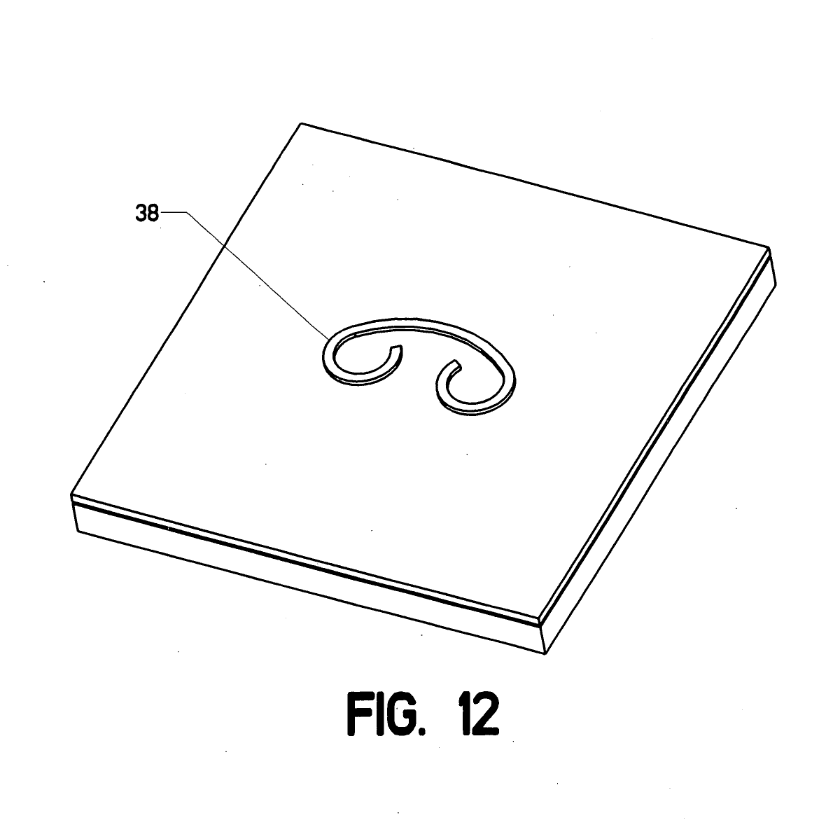

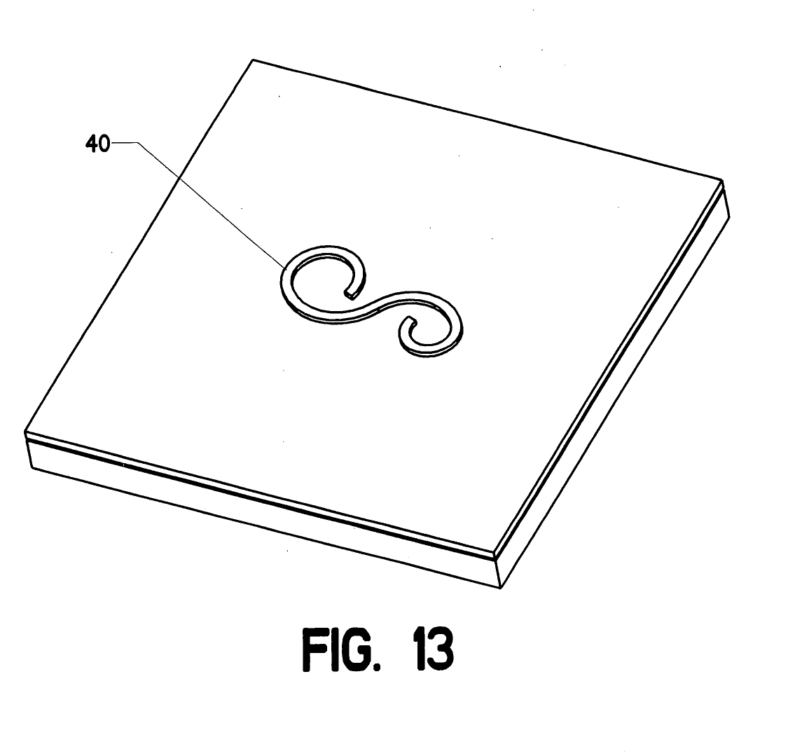

While FIG. 6, FIG. 7, FIG. 8, FIG. 9, and FIG. 10 illustrate an Archimedean-spiral design, it is contemplated that any type of relief that induces the self-trapping of filiforms can be patterned on the coating. FIG. 11 shows how convex diamond 34 can also be used to create diamond pattern 36. Also, FIG. 12 shows double spiral 38 and FIG. 13 shows “s” spiral 40 which could be used in similar patterns. Each of these patterns operates to entrap the filiforms by directing the filiforms to grow in such a way that the filiform ultimately entraps itself. As illustrated in FIG. 8, filiforms will similarly follow the pattern of convex diamond 34, double spiral 38, and “s” spiral 40 as they grow and ultimately become entrapped in each of their respective entrapment regions.

As illustrated in the aforementioned examples, “paths” can be created in many different shapes to promote the self-entrapment of filiform. Any path that directs the active head of the filiform to propagate in such a direction that the active head will become substantially surrounded by the inactive tail will work. Each of the aforementioned paths is configured to cause the filiform to propagate in such a direction that the inactive filiform tail creates an inactive perimeter around an entrapment region, where the active filiform head propagates angularly about the entrapment region. When the active filiform head is finally forced to enter the entrapment region, the filiform will become entrapped and will no longer propagate.

Although the preceding description contains significant detail, it should not be construed as limiting the scope of the invention but rather as providing illustrations of the preferred embodiments of the invention. As an example, it is shown that embedding patterns on coated metal surfaces promotes the self-entrapment of filiform. Other methods for creating structural variations in surface thickness and composition can be used such as screen printing and surface etching.

In addition, patterns can be embedded in the coating in such a way that its thickness is not affected. For example, light-controlled patterning can be used to vary the coating's chemical composition or porosity. Since corrosion occurs where moisture and oxygen diffuse through the coating and react with the metal substrate, the direction of filiform growth can be controlled by spatial variation of coating porosity. Patterns of porosity variation can be used much like patterns of thickness variation to promote filiform entrapment as filiforms will follow paths of higher porosity.

Having herein described our invention, we claim:

1. A structure imparted into a painted surface to promote the self-entrapment of a filiform, said filiform having an active head and an inactive tail, said structure comprising:
a. a path of structural variation in said painted surface, said path configured to induce said active head of said filiform to propagate therethrough; and
b. wherein said path is shaped to direct said active head of said filiform to propagate in such a direction that said active head becomes substantially surrounded by said inactive tail, thereby causing said filiform to become entrapped.

2. The structure of claim 1, wherein said path is configured to cause said filiform to propagate in such a direction that said inactive filiform tail creates an inactive perimeter around an entrapment region.

3. The structure of claim 1, wherein said path is configured to induce said active head of said filiform to propagate angularly about an entrapment region.

4. The structure of claim 1, wherein said path is substantially spiral in shape.

5. The structure of claim 1, wherein said structure is defined as a region of increased coating thickness.

6. The structure of claim 1, wherein said structure is defined as a region of increased porosity.

7. The structure of claim 1, said path further comprising a plateau, said plateau running the length of said path and having a paint coating of greater thickness than the adjacent portions of said painted surface.

8. The structure of claim 1, said path including:
a. a first end;
b. a second end;
c. a first spiral proximal to said first end; and
d. a second spiral proximal to said second end.

9. The structure of claim 1, wherein said structure is stamped on said painted surface while the paint on said painted surface is wet.

10. The structure of claim 1, further comprising a second path, said second path angularly offset with respect to said path.

11. A structure imparted into a painted surface to promote the self-entrapment of a filiform, said filiform having an active head and an inactive tail, said structure comprising:
a. a path of structural variation in said painted surface, said path configured to induce said active head of said filiform to propagate therethrough; and
b. wherein said path is shaped to cause said filiform to propagate in such a direction that said inactive filiform tail creates an inactive perimeter around an entrapment region.

12. The structure of claim 11, wherein said path is configured to induce said active head of said filiform to propagate angularly about said entrapment region.

13. The structure of claim 11, wherein said path is substantially spiral in shape.

14. The structure of claim 11, said path further comprising a plateau, said plateau running the length of said path and having a paint coating of greater thickness than the adjacent portions of said painted surface.

15. A structure imparted into a painted surface to promote the self-entrapment of a filiform, said filiform having an active head and an inactive tail, said structure comprising:
a. a path of structural variation in said painted surface, said path configured to induce said active head of said filiform to propagate therethrough; and
b. wherein said path is configured to induce said active head of said filiform to propagate angularly about an entrapment region.

16. The structure of claim 15, wherein said structure is defined as a region of increased porosity.

17. The structure of claim 15, wherein said path is configured to induce said active head of said filiform to propagate angularly about an entrapment region.

18. The structure of claim 15, wherein said path is substantially spiral in shape.

19. The structure of claim 15, said path further comprising a plateau, said plateau running the length of said path and having a paint coating of greater thickness than the adjacent portions of said painted surface.

20. The structure of claim 15, wherein said structure is defined as a region of increased coating thickness.
